(19) United States
(12) Patent Application Publication
(10) Pub. No.: US 2011/0036678 A1
(43) Pub. Date: Feb. 17, 2011

(54) ELECTROMAGNETIC CLUTCH

(75) Inventors: Takeshi Hashizume, Aichi (JP); Daisuke Toyama, Aichi (JP); Nobuo Aoyama, Aichi (JP)

Correspondence Address: BUCHANAN, INGERSOLL & ROONEY PC, POST OFFICE BOX 1404, ALEXANDRIA, VA, 22313-1404, US

(73) Assignee: Aisin Seiki Kabushiki Kaisha, Kariya-shi (JP)

(21) Appl. No.: 12/671,869

(22) PCT Filed: Nov. 4, 2008
(86) PCT No.: PCT/JP2008/070031

§ 371 Date: Feb. 2, 2010

(30) Foreign Application Priority Data
Nov. 15, 2007 (JP) 2007-296920
Nov. 15, 2007 (JP) 2007-296921
Nov. 15, 2007 (JP) 2007-296922
Oct. 30, 2008 (JP) 2008-279994

(51) Int. Cl. F16D 27/04; F16D 27/00

(52) U.S. Cl. 192/84.91; 192/84.1

(57) ABSTRACT

An electromagnetic clutch includes a worm wheel driven by a drive motor, an armature rotated in operative association with the worm wheel, a rotor rotatable about a same axis as the armature, an electromagnetic coil configured to cause the rotor to generate a magnetic force for causing the rotor and the armature to be moved and pulled into contact with each other along the rotational axis by the magnetic force, and an elastic member interposed between the rotor and the armature, one side of the elastic member being fixed to one of the rotor and the armature, the other side of the elastic member being in slidable contact with the other of the rotor and the armature, the elastic member urging the rotor and the armature in directions away from each other.

### TECHNICAL FIELD

The present invention relates to an electromagnetic clutch including a worm wheel rotatably driven by a motor, an armature rotatable in operative association with the worm wheel, a rotor rotatable about a same axis as the armature, and an electromagnetic coil configured to cause the rotor to generate a magnetic force for causing the rotor and the armature to be moved and pulled into contact with each other along the rotational axis by the magnetic force.

### BACKGROUND ART

With this type of electromagnetic clutch in operation, in response to supply of electric power to the electromagnetic coil, the armature is pulled into contact with the rotor, whereby the armature and the rotor are co-rotated and power from a drive motor is transmitted to the rotor side. On the other hand, when no electric power is supplied to the electromagnetic coil, the armature and the rotor are rendered rotatable relative to each other.

Patent Document 1 discloses such electromagnetic clutch as above in which the armature is suspended via a dish spring from a member rotatable with this armature, so that the armature and the rotor are opposed to each other via a gap therebetween. With this electromagnetic clutch, when power of the drive motor is to be transmitted to the rotor, with the magnetic force generated in response to the supply of power to the electromagnetic coil, the armature is pulled into contact with the rotor against the elastic force of the dish spring. On the other hand, when the power transmission to the rotor is to be interrupted, the power supply to the electromagnetic coil is stopped, whereby the armature is detached from the rotor under the elastic force of the dish spring. In this way, when the power transmission is interrupted, the armature is caused to be moved away from the rotor. With this, generation of increase in the free rotation torque and generation of noise due to slidable contact between the armature and the rotor, when the armature and the rotor are rotated relative to each other.

However, with the electromagnetic clutch disclosed in Patent Document 1, due to the arrangement of the armature being suspended via the dish spring, there exist a significant number of parts that affect the size of the gap between the rotor and the armature, so that significant error tends to exist in the size of the gap. For this reason, in order to allow reliable detachment between the armature and the rotor, there was a need to set the size of the inter armature-rotor gap large, with taking such size error into consideration. Further, due to this necessity of increasing the inter armature-rotor gap, a large magnetic force becomes necessary to ensure reliable attracted contact of the armature to the rotor, which necessity in turn leads to necessity of enlarging the electromagnetic coil. For this reason, for effective prevention of free rotation torque increase and noise generation, physical enlargement of the electromagnetic clutch was unavoidable.

Patent Document 2 discloses an electromagnetic clutch wherein an annular recess is formed in the vicinity of an outer periphery of a face of a disc-like rotor formed of a magnetic material opposed to an armature, and this recess accommodates an electromagnetic coil to be rotatable in unison with a rotor. In this rotor, an inner peripheral wall portion of the recess and an outer peripheral wall portion of the rotor are formed substantially perpendicular relative to the bottom portion, and a face of the rotor opposed to the armature and the inner peripheral wall portion of the recess are formed substantially perpendicular relative to each other. With these arrangements, the electromagnetic coil, the inner peripheral wall portion and the outer peripheral wall portion are disposed in proximity each other and the air gap between the rotor and the armature is reduced, so as to enable reliable transmission of the magnetic force of attraction to the armature. As a result, reliable attracted contact between the rotor and the armature can be realized without using a very large electromagnetic coil, so that the entire apparatus may be formed compact.

However, in Patent Document 2, if the above-described rotor is to be formed through e.g. a drawing work on a plate member formed of a magnetic material, there is the need to form the recess having the inner peripheral wall portion and the outer peripheral wall portion erect substantially perpendicular relative to the bottom portion. In this, forming the recess in the manner above is extremely difficult since the border between the inner peripheral wall portion of the recess and the opposing face of the rotor opposed to the armature will not be formed perpendicular, but will tend to be formed rather roundish. For this reason, the rotor needs to be formed by cutting, thus inviting cost increase.

### Patent Document 1: Japanese Patent Application “Kokai” No. 2007-78103

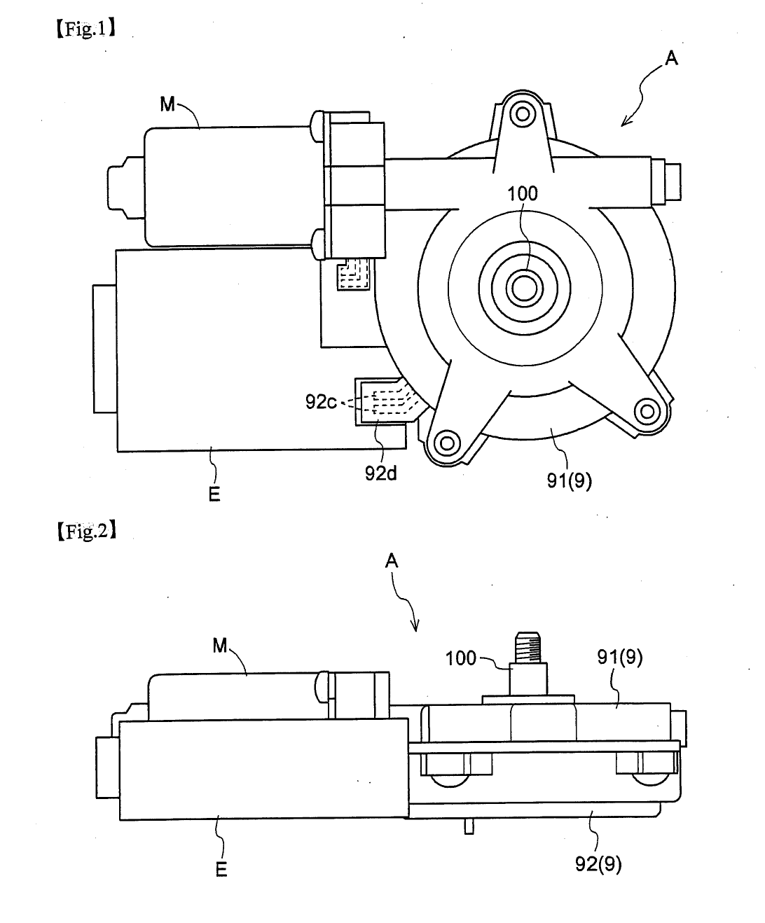

Patent Document 2: Japanese Patent Application “Kokai” No. 2007-139028 (paragraph 0025 and FIG. 1).

### DISCLOSURE OF THE INVENTION

The present invention has been made in view of the above-described drawbacks and its object is to provide, at low costs, an electromagnetic clutch that is formed compact and that can prevent increase of free rotation torque and noise generation.

According to the first characterizing feature of the present invention, an electromagnetic clutch comprises:

a worm wheel driven by a drive motor;

an armature rotated in operative association with the worm wheel;

a rotor rotatable about a same axis as the armature;

an electromagnetic coil configured to cause the rotor to generate a magnetic force for causing the rotor and the armature to be moved and pulled into contact with each other along the rotational axis by the magnetic force; and

an elastic member interposed between the rotor and the armature, one side of the elastic member being fixed to one of the rotor and the armature, the other side of the elastic member being in slidable contact with the other of the rotor and the armature, the elastic member urging the rotor and the armature in directions away from each other.

With the interposition of the elastic member between the armature and the rotor as in the above-described construction, with using either one of the armature and the rotor, the gap relative to the other will be set. Therefore, it is possible to reduce the size error and/or assembly error of the members relative to the gap size. As a result, even if the gap is not formed so large, inadvertent contact between the armature and the rotor can be effectively prevented. Further, since there is no need to form the gap between the armature and the rotor so large, enlargement of the electromagnetic coil is not needed, either. Consequently, it has become possible to provide, at low costs, an electromagnetic clutch that is formed compact and that can prevent increase of free rotation torque and noise generation.

According to the second characterizing feature of the present invention, in a face of the rotor opposed to the armature, there is formed a recess for accommodating the electromagnetic coil, and the elastic member is provided in a space between the recess and the armature.

With the above construction, the elastic member is disposed with utilizing the recess provided for accommodating the electromagnetic coil. Hence, there is no need to provide any separate space for disposing the elastic member. So, further compactification (downsizing) becomes possible.

According to the third characterizing feature of the present invention, the recess and the elastic member are formed annular.

With the above construction, the elastic member is to be interposed between the armature and the rotor along the entire peripheries thereof. As a result, the positional relationship between the armature and the rotor can be maintained in a reliable manner.

According to the fourth characterizing feature of the present invention, the elastic member includes a pawl portion along the peripheral direction, the pawl portion being fixed to one of the rotor and the armature.

If the elastic member has a pawl portion along the peripheral direction as in the above construction, the elastic member can be fixed in a reliable with no looseness in the plane thereof. Therefore, the positional relationship between the armature and the rotor can be maintained in a reliable manner.

According to the fifth characterizing feature of the present invention, the elastic member includes an annular slidable contacting portion configured to slidably contact either one of the rotor and the armature and an annular tapered portion extending with tapering such that the diameter thereof progressively decreases toward the other of the rotor and the armature.

With the above construction, as the annular tapered portion is elastically deformed along the central axis of its annular shape, the elastic member exerts its elastic force. Therefore, as compared with a case of using e.g. a coil spring having a same or similar spring constant, the electromagnetic clutch can be formed more compact in the direction of the central axis. Further, since the elastic member has an annular slidable contacting portion separately from the tapered portion, the armature or the rotor can be retained in a reliable manner.

According to the sixth characterizing feature of the present invention, the elastic member comprises a dish spring.

As compared with e.g. a coil spring having a same or similar spring constant, the dish spring is more compact in the direction of its elastic deformation. Hence, if the elastic member comprises a dish spring as in the above construction, the electromagnetic clutch can be formed compact in the direction along which the rotor and the armature are moved away from each other.

According to the seventh characterizing feature of the present invention, the elastic member includes a plurality of slits extending either radially inward from its outer peripheral end or radially outward from its inner peripheral end.

An annular elastic member, such as a dish spring, when exposed to a force along the central axis of the annular shape, is elastically deformed with its radially intermediate portion being flexed (bent). If the outer peripheral end or inner peripheral end is formed continuous, radial displacement of the outer peripheral portion or inner peripheral portion is restricted. For this reason, when the force becomes large, this may cause the intermediate portion to be flipped to the opposite side, and this flipping may generate a noise.

Then, if the elastic member includes a plurality of slits extending either radially inward from its outer peripheral end or radially outward from its inner peripheral end as in the above construction, when a force is applied in the direction of the center axis of the annular shape, displacement of the outer peripheral portion toward the radial outer side or displacement of the inner peripheral portion toward the radial inner side is allowed. Therefore, such flipping of the intermediate portion will less likely occur, thus generation of noise due to flipping can be restricted.

According to the eighth characterizing feature of the present invention, the elastic member is disposed along the vicinity of the outer peripheral portion of at least one of the rotor and the armature.

With the above construction, the elastic member is interposed along the vicinity of the outer peripheral portions of the armature and the rotor along the entire peripheries thereof. Therefore, it becomes possible to reduce angular displacement amounts of the armature and the rotor relative to the elastic deformation amount of the elastic member. As a result, the positional relationship between the armature and the rotor can be maintained in a reliable manner.

According to the ninth characterizing feature of the present invention, the elastic member is fixed in the vicinity of the inner peripheral wall portion of the recess and the elastic member extends radially outward such that an outer peripheral portion thereof is located adjacent the outer peripheral wall portion of the recess.

With the above construction, the elastic member is fixed in the vicinity of the inner peripheral wall portion of the recess and the elastic member extends to the vicinity of the outer peripheral wall portion of the recess. With such large setting of the radial width of the elastic member, as compared with a short width, the elastic deformation of the elastic member can proceed smoothly. Therefore, when the rotor and the armature are moved away from each other, the elastic force will encounter no sudden load or resistance, whereby the operation of the electromagnetic clutch can be stable.

According to the tenth characterizing feature of the present invention, the elastic member has a low friction layer that slidably contacts the rotor or the armature.

If the elastic member has a low friction layer that slidably contacts the rotor or the armature as in the above construction, when the rotor and the armature are rotated relative to each other, the elastic member can slide smoothly relative to the rotor or the armature. Therefore, the relative rotation between the rotor and the armature will not be interfered, and generation of sliding noise and friction of the components can be restricted and also the electromagnetic clutch can operate in a favorable manner.

According to the eleventh characterizing feature of the present invention, the rotor is formed by a drawing work on a material and the inner peripheral wall portion of the recess is configured such that its inner diameter progressively decreases from a bottom portion of the recess toward its opening side.

If the rotor is formed by a drawing work on a material as in the above construction, there is no need for cutting work for instance. So, the manufacture costs of the rotor can be reduced. Further, if the inner peripheral wall portion is configured as described above, as compared with a case of forming the inner peripheral wall portion perpendicular relative to the bottom portion, it is possible to prevent unneeded extension of the inner peripheral wall portion in the course of drawing work, thus ensuring sufficient thickness for the inner peripheral wall portion. Moreover, the bending amount of the material at the border between the inner peripheral face of the recess and the opposition face to the armature may be small, thus preventing the border portion from being formed roundish. As a result, the air gap at the border portion relative to the armature can be reduced. Therefore, it becomes easier to secure sufficient force of attraction for the rotor relative to the armature and there is no need to employ a very large electromagnetic coil. Consequently, the electromagnetic clutch may be formed even more compact at even lower costs.

According to the twelfth characterizing feature of the present invention, when the rotor and the armature are pulled into contact with each other, only the end face of the outer peripheral wall portion of the recess opposed to the armature comes into contact with the armature.

If only the end face of the outer peripheral wall portion of the recess opposed to the armature comes into contact with the armature as in the above construction, the radius of contact between the rotor and the armature can be large, so that the rotational torque can be increased.

According to the thirteenth characterizing feature of the present invention, a radial width of the end face of the outer peripheral wall portion of the recess opposed to the armature and a radial width of the end face of the inner peripheral wall portion of the recess opposed to the armature are set such that areas of said end faces may be equal to each other.

With the above-descried setting of the radial widths of the end faces, passing magnetic flux densities of the end faces are rendered equal to each other, thus the magnetic flux may flow smoothly.

According to the fourteenth characterizing feature of the present invention, the rotor includes a first member comprising an outer peripheral wall portion, a bottom portion and an inner peripheral wall portion that together form the recess, and a second member engageable with the first member and supporting the first member rotatably about the rotational axis.

If the rotor is formed of two separate members, i.e. the first member and the second member, even when the annular recess is formed by a drawing work, the bottom portion of the recess becomes the bending side. Therefore, the border between the face of the rotor opposed to the armature and the inner peripheral wall of the recess may be formed substantially perpendicular, thus reducing the air gap relative to the armature. Hence, there is no need to employ a very large electromagnetic coil. Consequently, the electromagnetic clutch may be formed even more compact at even lower costs.

According to the fifteenth characterizing feature of the present invention, the second member is fitted under pressure to the inner side of the inner peripheral wall portion of the first member.

With this construction, with the simple arrangement of pressure-fitting the first member to the second member, the rotor can be formed. As a result, even more cost reduction is made possible.

According to the sixteenth characterizing feature of the present invention, the first member is formed of a magnetic material and the second member is formed of a non-magnetic material.

If the first member and the second member are formed of different materials as in the above construction, for the second member in particular, its forming material may be selected appropriately, with taking into consideration such factors as readiness of working, strength required in its fixing to the rotational shaft. Therefore, the manufacture of the rotor becomes easier and even further cost reduction is made possible.

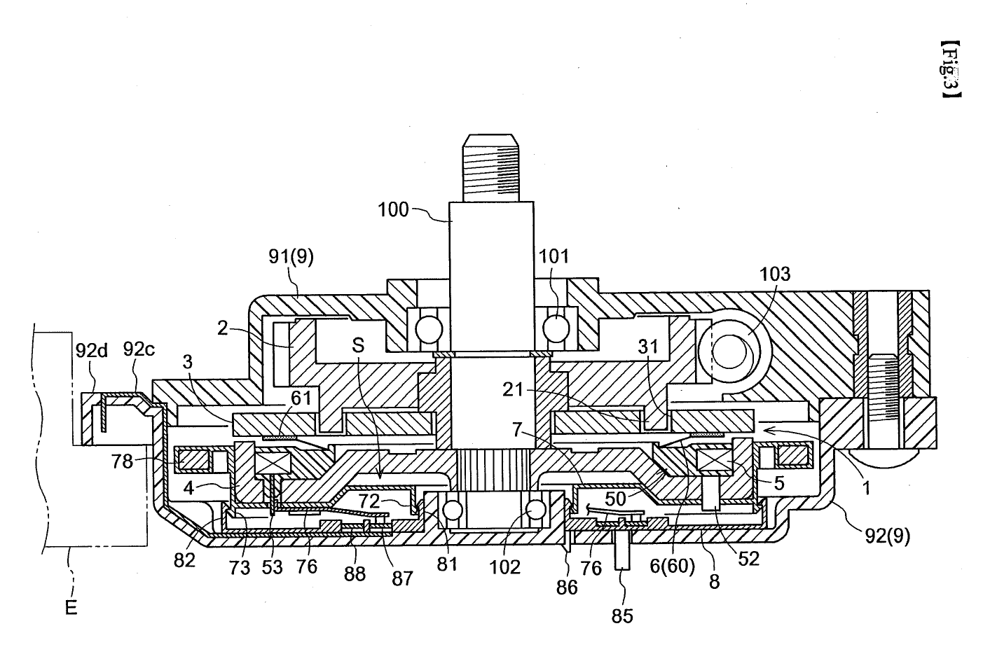

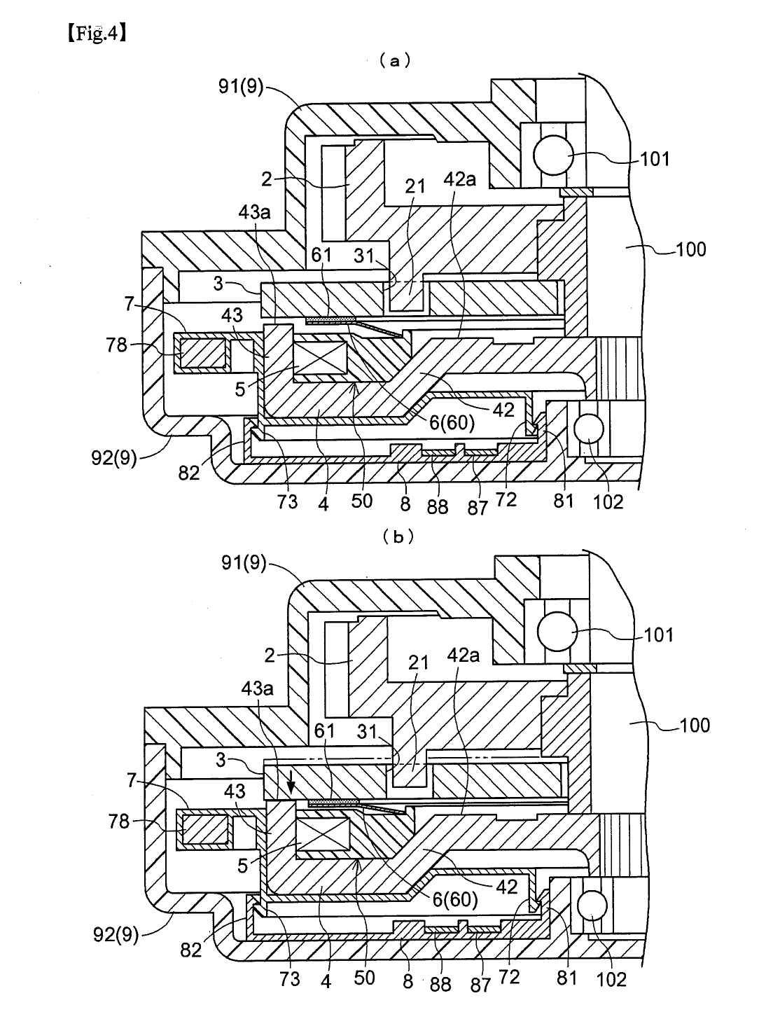

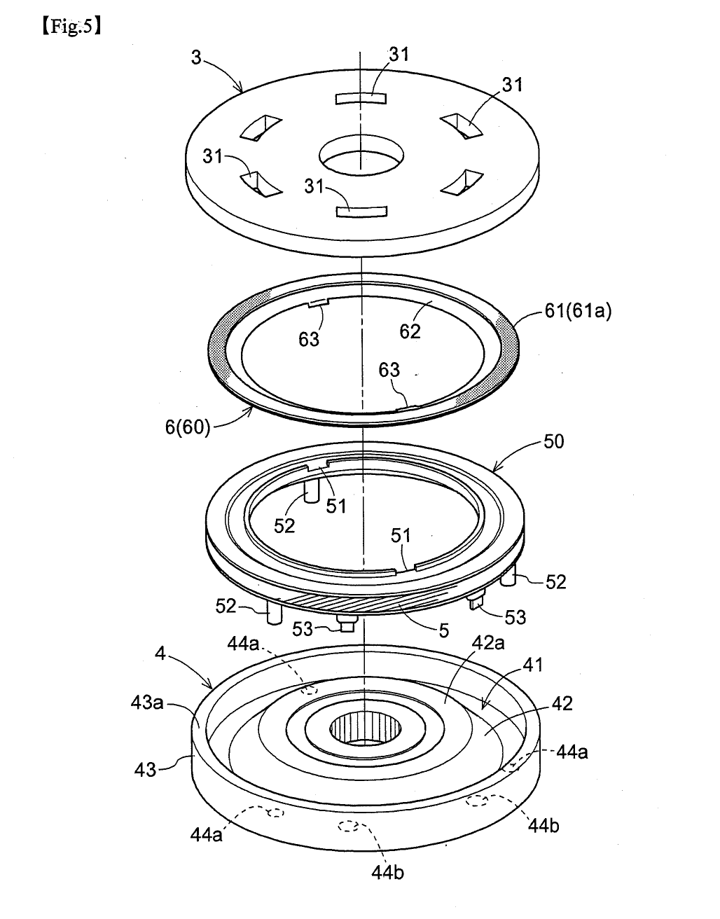

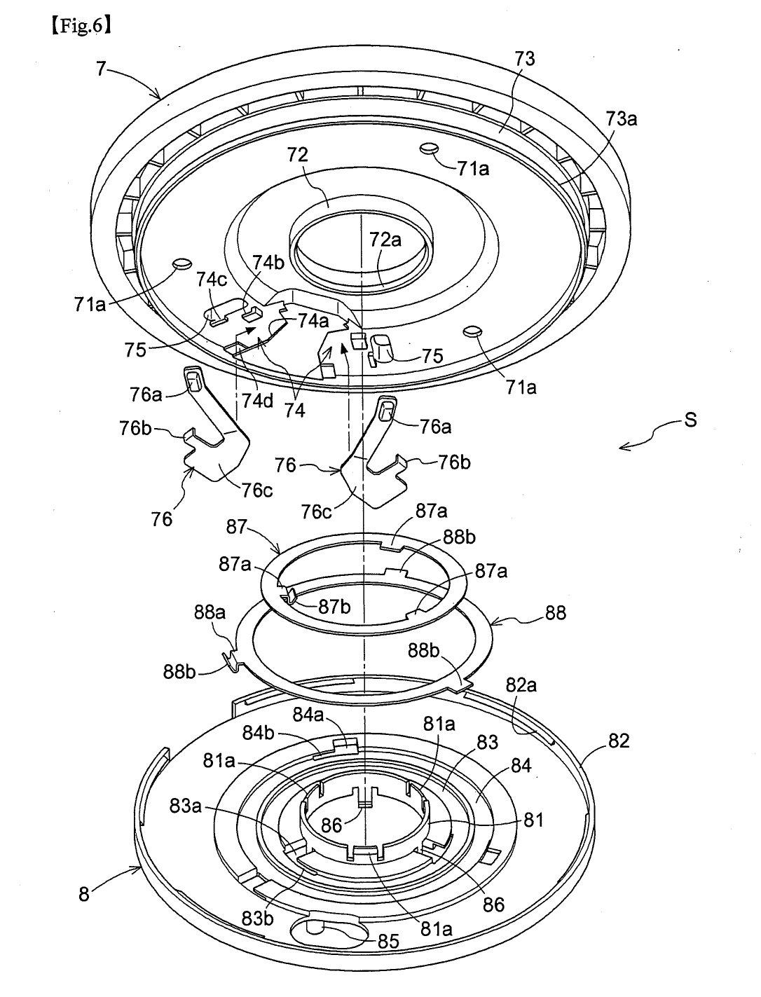

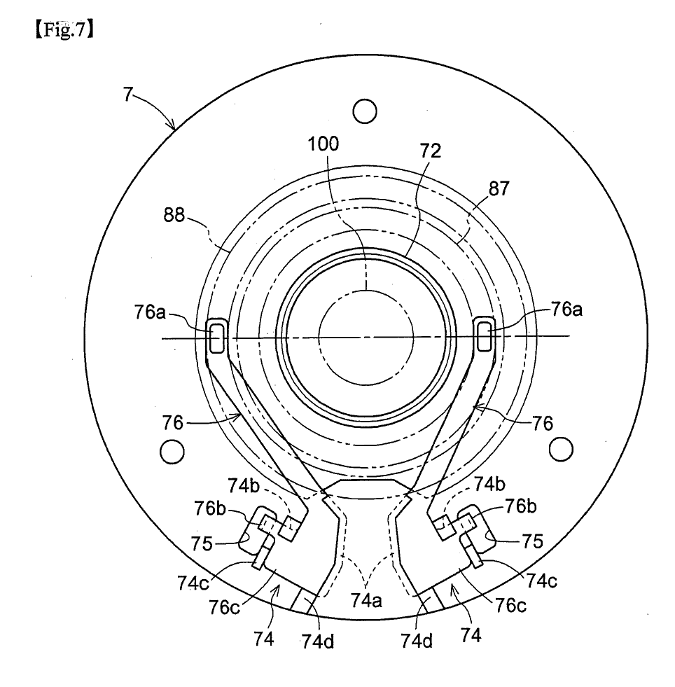

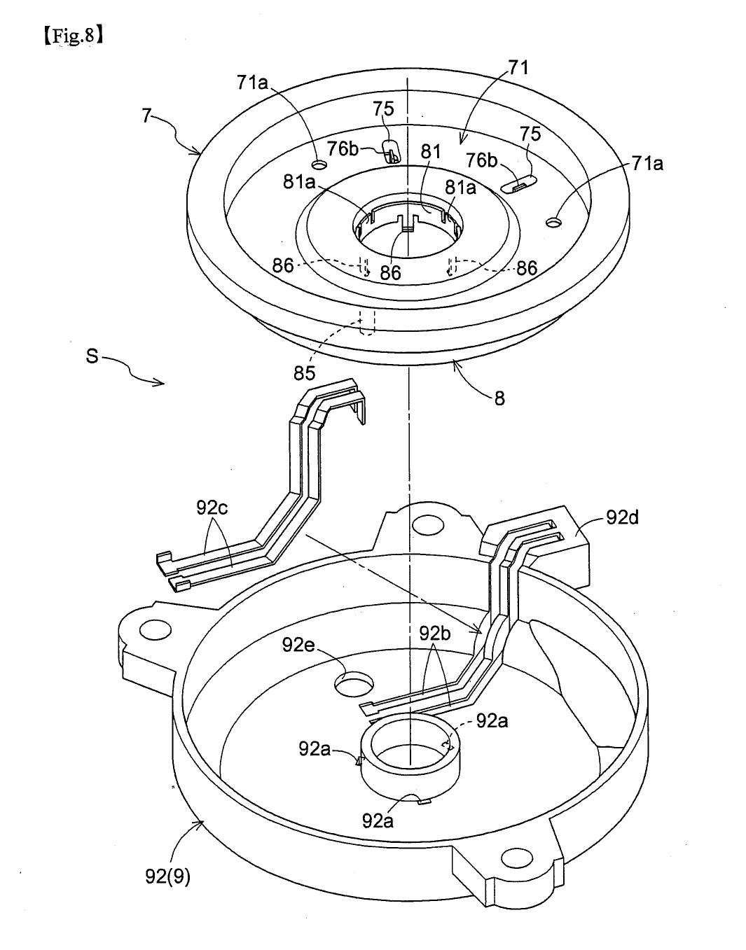

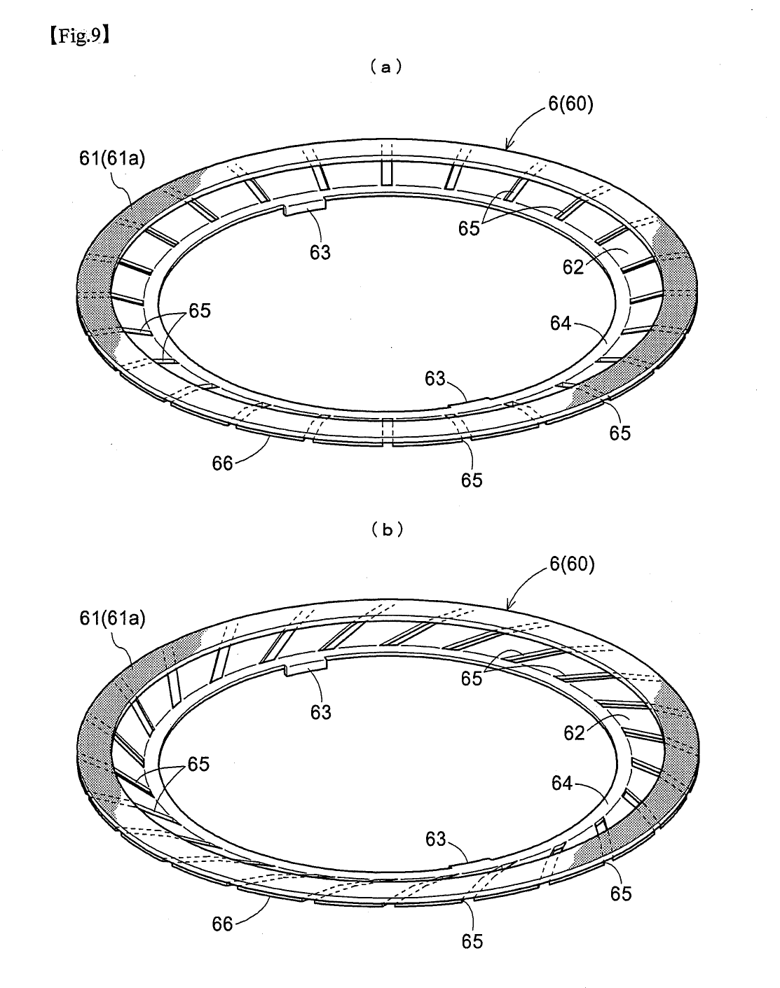

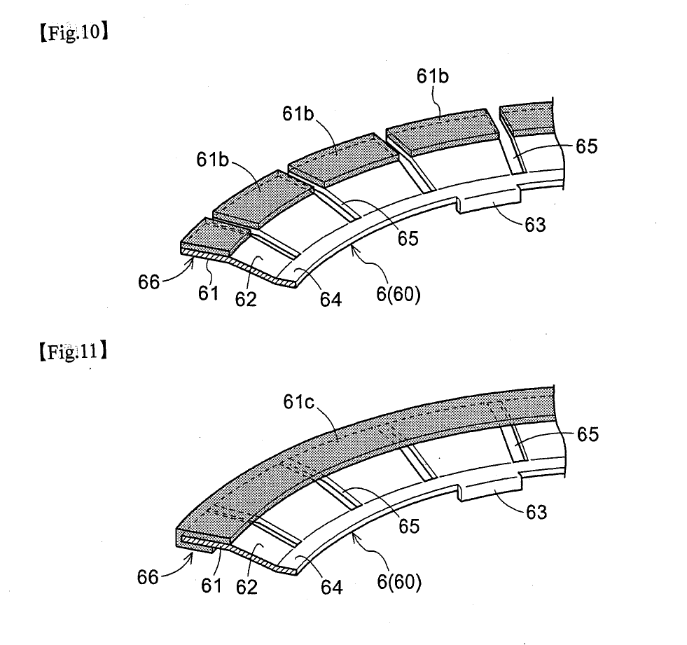

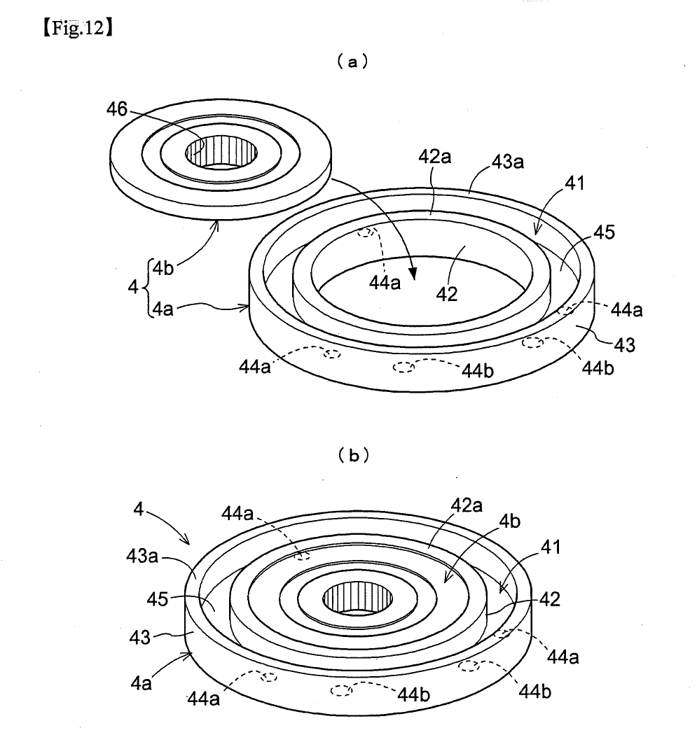

### BRIEF DESCRIPTION OF THE DRAWINGS

[FIG. 1] is a front view of an actuator using an electromagnetic clutch according to the present invention,

[FIG. 2] is a side view of the actuator using the electromagnetic clutch according to the present invention,

[FIG. 3] is a section view of the actuator using the electromagnetic clutch according to the present invention,

[FIG. 4] is a view illustrating an operation of the electromagnetic clutch according to the present invention,

[FIG. 5] is an exploded perspective view of the electromagnetic clutch according to the present invention,

[FIG. 6] is an exploded perspective view of a power supply mechanism,

[FIG. 7] is a view showing a contacting condition between brush members and slip rings,

[FIG. 8] is a view illustrating assembly of the power supply mechanism,

[FIG. 9] (a) is a perspective view of an elastic member having slits provided in a radial pattern, (b) is a perspective view of an elastic member having slits provided in a vortex pattern,

[FIG. 10] is a perspective view in section showing low friction layers segmented in accordance with the slits,

[FIG. 11] is a perspective view in section showing a low friction layer having an angular hook-like cross sectional shape, and

[FIG. 12] (a) is an exploded perspective view of a rotor relating to a further embodiment, and (b) is a perspective view of the rotor.

### BEST MODE OF EMBODYING THE INVENTION

One embodiment of an electromagnetic clutch relating to the present invention will be described with reference to the accompanying drawings. The electromagnetic clutch relating to the present invention ma be used in e.g. an actuator A for a powered sliding door of an automobile.

The actuator A, as shown in FIG. 1, FIG. 2 and FIG. 3, includes, inside a cover member 9 consisting of a gear side cover member 91 and a power supply mechanism side cover member 92, a worm gear 103 for transmitting power of a drive motor M, an electromagnetic clutch 1 for engaging/disengaging transmission of the power of the drive motor M, a shaft 100 rotatably supported to the cover member 9 via bearings 101, 102 provided in the cover member 9, an output drum (not shown) rotatable in unison with the shaft 100 for opening/closing a slide door (not shown), a control unit E for controlling the power transmission engagement/disengagement of the electromagnetic clutch, and so on.

In operation, when the power of the drive motor M is transmitted to the shaft 100, the output drum is rotated, thereby to open/close the slide door. On the other hand, when the electromagnetic clutch 1 disengages the transmission of the drive power from the drive motor M, the shaft 100 and the output drum are rendered freely rotatable relative to the wheel gear, thus allowing manual opening/closing of the slide door.

As shown in FIG. 3, the electromagnetic clutch 1 includes a worm wheel 2 meshed with the worm gear 103, an armature 3 rotatable in operative association with the worm wheel 2, a rotor 4 rotatable about a same axis as the armature 3, an electromagnetic coil 5 configured to cause the rotor 4 to generate a magnetic force which causes the armature 3 and the rotor 4 to be moved along the rotational axis and pulled into contact with each other, and a power supply mechanism S for supplying electric power to the electromagnetic coil 5. In this embodiment, the electromagnetic coil 5 wound around a bobbin 50 is fixed to the rotor 4, so that the electromagnetic coil 5 and the rotor 4 are rotated in unison.

Further, in this electromagnetic clutch 1, the worm gear 103 and the armature 3 are supported to be rotatable relative to the shaft 100. On the other hand, the rotor 4 is supported to be rotatable in unison with the shaft 100.

As shown in FIG. 3 and FIG. 4, between the armature 3 and the rotor 4, there is interposed an elastic member 6 having one side thereof fixed to the rotor 4 side and the other side thereof slidably contacting the armature 3 side. In this embodiment, a dish spring 60 as the elastic member 6 is fixed to the bobbin 50 which is rotatable together with the rotor 4 and this dish spring slidably contacts the armature 3. With this, by the dish spring 60, the armature 3 and the rotor 4 are urged in directions away from each other.

The above-described armature 3, the rotor 4, the dish spring 60 and the power supply mechanism S have circular annular shapes and are arranged concentrically relative to the shaft 100.

The armature 3 is formed of such a material as iron, capable of being attracted by a magnetic force. Further, this armature 3 includes an arcuate hole portion 31 engageable with an arcuate projection 21 formed on the worm wheel 2. With this, the armature 3 is rotatable in operative association with the rotation of the worm wheel 2 and is movable along the axis of the shaft 100 closer to/away from the rotor 4.

As shown in FIG. 5, the rotor 4 is formed of a magnetic material so as to genera a force of attraction by the magnetism to the armature 3 upon supply of power to the electromagnetic coil 5. The rotor 4 forms an annular recess 41 configured to accommodate a bobbin 50 with the electromagnetic coil 5 wound thereabout, the annular recess being formed along the vicinity of the outer periphery of its face opposed to the armature 3. Further, at the bottom portion of the recess 11, there is formed a hole 44a into which a projection 55 of the bobbin to be described later is inserted and a hole 44b into which a terminal portion 53 is to be inserted. This recess 41 has an inner peripheral wall portion 42 formed with an inclination such that the inner diameter of the inner peripheral wall portion 42 of the recess 41 becomes smaller from the bottom portion to the upper side. On the other hand, an outer peripheral wall portion 43 of the recess 41 is formed substantially perpendicular. Therefore, from the bottom portion to the upper side, the width of the recess 41 becomes greater.

In this rotor 4, the area of an end face 43a of the outer peripheral wall portion 43 opposed to the armature 3 and the area of an end face 42a of the inner peripheral wall portion 42 opposed to the armature 3 are set equal to each other, so that the area of magnetic field passage may be same on the side of the outer peripheral wall portion 43 and on the side of the inner peripheral wall portion 42. That is to say, the radial width of the end face 42a is set greater than the radial width of the end face 43a.

With this type of electromagnetic clutch, in order to maintain the rotational torque constant, it is necessary to maintain constant the contacting portions between the armature 3 and the rotor 4. On the other hand, if the entire rotor 4 were configured to contact the armature 3, this might result in irregularity in the rotational torque, due to possible differences in the contacting portions depending on the individual products, due to e.g. manufacturing error or tolerance. Then, in the case of this rotor 4, an arrangement is made such that only a predetermined region in the vicinity of the outer periphery of the rotor 4 may contact the armature 3.

Specifically, in this rotor 4, the outer peripheral wall portion 43 has a higher profile than the inner peripheral wall portion 42, so that when the armature 3 is pulled, only the end face 43a of the outer peripheral wall portion 43 comes into contact with the armature 3. With use of such arrangement, the contacting portions between the armature 3 and the rotor 4 can be maintained constant, thus maintaining the rotational torque constant.

Further, there is also a need for causing the armature 3 and the rotor 4 to contact uniformly in the peripheral direction. To this end, a polishing treatment is provided to the contacting portion of the rotor 4 to come into contact with the armature 3. In this, since the contacting portion to come into contact with the armature 3 is limited to the end face 43a, the portion requiring such polishing treatment can be reduced, so that the manufacture cost can be reduced.

The bobbin 50, as shown in FIG. 5, is formed of a resin material and has a circular annular shape, having flange portions formed erect at opposed terminal ends in its outer periphery, with a length of the electromagnetic coil 5 being wound between the two flange portions. In this embodiment, in correspondence with the shape of the recess 41, the bobbin 50 has a tapered shape as viewed in section perpendicular to the peripheral direction. Further, the bobbin 50 includes, along the peripheral direction and on its inner peripheral side, a plurality (provided at two positions in this embodiment) of groove portions 51 (or slit-like holes) in which pawl portions 63 of a dish spring 60 are to be inserted. And, on the back side of the opposing face, there are provided projections 52 for fixing the bobbin 50 to the rotor 4 and terminal portions 53 for supplying power to the electromagnetic coil 5.

The dish spring 60 is formed of an elastic material such as phosphor bronze. Further, as shown in FIG. 5, the dish spring 60 includes an annular slidable contacting portion 61 for coming into slidable contact with the armature 3, a tapered portion 62 extending with tapering such that its diameter becomes smaller from the inner peripheral portion of the slidable contacting portion 61 to the lower side, and the pawl portions 63 formed at the lower end of the tapered portion 62.

Further, in the face of the slidable contacting portion 61 opposed to the armature 3, a low friction layer 61a is formed. This low friction layer 61a is not particularly limited as long as it has abrasion resistance and low friction property. For instance, this can be formed of a layer of resin such as polyacetal having abrasion resistance and low friction property. Incidentally, the low friction layer 61a may be provided at the portion not on the dish spring 60 side, but on the armature 3 side at its portion slidably contacting the dish spring 60. With this arrangement, the dish spring 60 can slide smoothly relative to the armature 3 even when the armature 3 and the rotor 4 are rotated relative to each other. Therefore, the relative rotation between the armature 3 and the rotor 4 will not be interfered and generation of noise and frictional wear of the members due to sliding can be restricted and also the electromagnetic clutch 1 can be operated in a favorable manner.

As shown in FIG. 5, the bobbin 50 with the electromagnetic coil 5 wound thereabout is housed within the recess 41 of the rotor 4. In this housed condition, the projecting portions 52 of the bobbin 50 are inserted into holes 44a defined in the bottom portion of the recess 41 and the terminal portions 53 are inserted into holes 44b defined in the bottom portion of the recess 41, whereby the electromagnetic coil 5 is fixed to the rotor 4 to be rotatable therewith. The projecting portions 52 and the terminal portions 53 extend through the holes 44a, 44b to project from the back face of the rotor 4.

Further, into the groove portions 51 (slit-like holes) of the bobbin 50, the pawl portion 63 of the dish spring 60 are inserted, whereby the dish spring 60 is fixed to the bobbin 50. In the case of the slit-like holes configuration, the prevention of inadvertent detachment of the dish spring 60 can be made more reliable. The dish spring 60 extends form the fixing position adjacent the inner peripheral wall portion 42 of the recess 41 to the radially outer side, with the outer peripheral portion of the slidable contacting portion 61 being located adjacent the inner peripheral side of the outer peripheral wall portion 43, and comes into slidable contact with the armature. 3.

In the above, as shown in FIG. 3 and FIG. 4, the thickness of the bobbin 50 and the height of the outer peripheral wall portion 43 are set such that when the bobbin 50 is accommodated in the recess 41, the position of the end face 43a of the outer peripheral wall portion 43 of the recess 41 may be higher than the position of the upper face of the bobbin 50. With this, the dish spring 60 is disposed in the space between the armature 3 and the recess 41. In this, with the above-described arrangement of inclining the inner peripheral wall portion 42 to provide the recess with tapering, the space for disposing the dish spring 60 may be secured reliably.

Advantageously, the rotor 4 is formed by effecting a drawing work on a plate-like magnetic material. In this case, the erect angle of the inner peripheral wall portion 42 relative to the bottom portion 44 should preferably be near 90 degrees, for the sake of forming the rotor 4 compact. On the other hand, for the sake of prevention of roundishness of the border portion between the inner peripheral face of the recess 41 and the face opposed to the armature 3, the angle should preferably be greater than 90 degrees. For balancing these, the angle preferably ranges from 120 to 150 degrees approximately, more preferably, 135 degrees approximately.

If the inner peripheral wall portion 42 of the recess 41 is inclined as described above, it is possible to prevent unneeded extension of the inner peripheral wall portion 42 in the course of drawing work, thus ensuring sufficient thickness for the inner peripheral wall portion 42. Moreover, the bending amount of the material at the border between the inner peripheral face of the recess 41 and the opposition face to the armature 3 may be small, thus preventing the border portion from being formed roundish. As a result, the air gap at the border portion relative to the armature 3 can be reduced.

With this electromagnetic clutch 1, as shown in FIG. 4 (a), when no power is supplied to the electromagnetic coil 5, the armature 3 and the rotor 4 are kept apart from each other under the urging force of the dish spring 60. Under this condition, as the armature 3 and the low friction layer 61a formed in the slidable contacting portion 61 of the dish spring 60 slide each other, the armature 3 and the rotor 4 are rendered rotatable relative to each other.

On the other hand, as shown in FIG. 4 (b), when power is supplied to the electromagnetic coil 5, with the magnetic force from the electromagnetic coil, the armature 3 is pulled into contact with the rotor 4 against the urging force of the dish spring 60. Under this condition, as the armature 3 and the end face 43a of the outer peripheral wall portion 43 of the rotor 4 are in pulled contact with each other, the armature 3 and the rotor 4 are rotatable in unison, so that the power from the drive motor M is transmitted to the rotor 4.

As described above, as the dish spring 60 is interposed between the armature 3 and the rotor 4, with either one of the armature 3 and the rotor 4 as a “reference”, the gap relative to the other is to be set. Therefore, it is possible to reduce the size error and/or assembly error of the members relative to the gap size. As a result, even if the gap is not formed so large, inadvertent contact between the armature 3 and the rotor 4 can be effectively prevented. Further, since there is no need to form the gap between the armature 3 and the rotor 4 so large, enlargement of the electromagnetic coil 5 is not needed, either. Consequently, it has become possible to provide, at low costs, the electromagnetic clutch 1 that is formed compact and that can prevent increase of free rotation torque and noise generation.

Next, an example of the power supply mechanism S for supplying electric power to the electromagnetic coil 5 will be explained. As shown in FIG. 3, with this power supply mechanism S, by causing rings 87, 88 electrically connected to a power source (not shown) via a control unit E (see FIG. 1) and brush members 76 electrically connected to the electromagnetic coil 5 are brought into contact with each other, the electric power is supplied to the electromagnetic coil 5. That is to say, in association with rotation of the electromagnetic coil 5 (rotor 4), the brush members 76 are caused to slide over the slip rings 87, 88, whereby electric power is supplied to the electromagnetic coil 5, regardless of the angular phase of the electromagnetic coil 5 (rotor 4).

As shown in FIG. 6, in addition to the slip rings 87, 88 and the brush members 76 described above, the power supply mechanism S further includes a slip ring fixing member 8 fixing the slip rings 87, 88, a brush fixing member 7 fixing the brush members 76, etc. The slip ring fixing member 8 and the brush fixing member 7 are rotatable relative to each other, with the slip rings 87, 88 being opposed to the brush members 76 and these members 8, 7 are integrated into a unit with prevention of axial withdrawal relative to each other.

As shown in FIG. 6, in the face of the slip ring fixing member 8 opposed to the brush fixing member 7, there are formed two annular recesses 83, 84 arranged concentrically about the same rotational axis and the slip rings 87, 88 are fixed to the respective recesses 83, 84. On the sides of the respective recesses 83, 84, arcuate slits 83b, 84b are formed. In this particular embodiment, the slit 83b is formed on the inner peripheral side of the small-diameter recess 83 and the slit 84b is formed on the outer peripheral side of the large-diameter recess 84. These slits 83b, 84b are communicated with openings 83a, 84a opened in the faces opposed to the brush fixing member 7 and communicated also with the back side of the opposing face. Further, on the side of the opposing face, an inner peripheral wall portion 81 is formed along the inner periphery of the slip ring fixing member 8 and an outer peripheral wall portion 82 is formed along the outer periphery of the same. And, on the outer peripheral face of the inner peripheral wall portion 81 and the inner peripheral face of the outer peripheral wall portion 82, there are formed a plurality of arcuate-shaped, anti-withdrawal projections 81a, 82a along the peripheral direction for preventing inadvertent withdrawal relative to the brush fixing member 7. On the other hand, on the side of the back face of the opposing face, there are formed engaging portions 86 to be engaged with holes 92a formed in the power supply mechanism Side cover member 92, and a phase fixing projection 85 to be inserted into a hole 92e defined in the power supply mechanism Side cover member 92 thereby to fix the phase in the rotational direction of the power supply mechanism S.

As shown in FIG. 6, in the face of the brush fixing member 7 opposed to the slip ring fixing member 8, there is formed a fixing portion 74 for the attachment of the brush member 76. This fixing portion 74 includes a slit 74a extending radially of the brush fixing member 7 and a slit 74b extending along the peripheral direction in the vicinity of the radial inner end of the slit 74a. Further, this fixing portion 74 includes a projection 74d extending along the peripheral direction in the vicinity of the radial outer end of the slit 74a and a projection 74c extending along the peripheral direction in opposition to the slit 74a. Further, adjacent the fixing portion 74, there are formed holes 75 into which terminal portions 76b of the brush member 76 to be described later are inserted. And, the fixing portion 74 and the holes 75 are formed in correspondence with each brush member 76.

Further, as shown in FIG. 6, the brush fixing member 7 forms an inner peripheral wall portion 72 and an outer peripheral wall portion 73, and on the inner peripheral side of the inner peripheral wall portion 72 and on the outer peripheral side of the outer peripheral wall portion 73, there are formed annular anti-withdrawal projections 72a, 73a for preventing inadvertent withdrawal in the axial direction between the brush fixing member 7 and the slip ring fixing member 8. Further, as shown in FIG. 8, in the back side of the opposing face of the brush fixing member 7, there is formed a concave rotor holding portion 71 for holding the rotor 4 to be rotatable therewith.

The brush member 76 is formed of an elastic material having conductive property and includes a brush portion 76a for coming into contact with the slip ring 87, 88, the terminal end portion 76b for coming into contact with the terminal portion 53 formed in the coil bobbin 50, and a fixed portion 76c to be attached to the brush fixing member 7.

Further, this power supply mechanism S includes the two slip rings as slip rings, i.e. the small slip ring 87 and the large slip ring 88. These two slip rings 87 and 88 are disposed concentrically, with one of them being connected to one terminal of the power source, the other thereof being connected to the other terminal of the power source. These slip rings 87, 88 are formed of an elastic material having conductivity and include annular portions for coming into slidable contact with the brush member 76 and pawl portions 87a, 88a projecting radially from the annular portions. A plurality of such pawl portions 87a, 88a (three of them are provided in the case of the present embodiment) are provided along the peripheral direction, and in one of the pawl portions 87a, 88a, a terminal portion 87b, 88b is formed by bending the leading end of this pawl portion 87a, 88a. These terminal portions 87b, 88b are electrically connected to the power source via a conducting member 92c to be described later. Further, in the instant embodiment, the large slip ring 88 forms the pawl portion 88a on its outer radial side and the small slip ring 87 forms the pawl portion 87a on the inner radial side.

Next, the mounting of the power supply mechanism S will be explained. First, mounting operations of the slip rings to the slip ring fixing member 8 will be described. As shown in FIG. 6, the pawl portions 87a, 88a of the slip rings 87, 88 are inserted from above into the openings 83a, 84a. Then, the slip rings 87, 88 are rotated, thereby to allow the pawl portions 87a, 88a to be inserted into the slits 83b, 84b. With this, the terminal portions 87b, 88b formed by bending the pawl portions 87a, 88a are caused to project from the slits to the back face side. Incidentally, the slip rings 87, 88 may be fixed to the slip ring fixing member 8 by the insert molding technique.

Next, mounting of the brush member 76 to the brush fixing member 7 will be explained. As shown in FIG. 6, as the fixed portion 76c is caused to slide along the slit 74a and the projection 74c from the radially outer side to the radially inner side, thereby to engage the radially inner end portion of the fixed portion 76c with the slit 74b. Further, with elastic deformation of the fixed portion 76c, the projection 74d is caused to ride over the radially outer end portion of the fixed portion 76c, thereby to establish contact between the end face of the fixed portion 76c and the end face of the projection 74d. With this, the slit 74a and the projection 74d function to restrict movement of the fixed portion 76c in the peripheral direction and the slit 74a and the projection 74d function to restrict movement of the fixed portion 76c in the radial direction and the brush member 76 is mounted to the brush fixing member 7. Under this condition, as shown in FIG. 8, the terminal portion 76b is inserted into the hole 75 to project on the side of the rotor holding portion 71. Incidentally, the brush member 76 may be fixed to the brush fixing member 7 by the insert molding technique.

Next, the assembly between the slip ring fixing member 8 and the brush fixing member 7 will be explained. As shown in FIG. 6, as the brush fixing member 7 is inserted into the gap between the inner peripheral wall portion 81 and the outer peripheral wall portion 82 of the slip ring fixing member 8, the brush fixing member 7 and the slip ring fixing member 8 are assembled into a unit. Here, the gap between the anti-withdrawal projection 72a and the anti-withdrawal projection 73a of the brush fixing member 7 is set to be slightly greater than the gap between the anti-withdrawal projection 81a and the anti-withdrawal projection 82a of the slip ring fixing member 8. With the elastic deformation of the resin material, the anti-withdrawal projection 72a and the anti-withdrawal projection 81a, and anti-withdrawal projection 73a and the anti-withdrawal projection 82a, are caused to ride over each other. With this, as shown in FIG. 7 and FIG. 8, the brush fixing member 7 and the slip ring fixing member 8 are combined into a unit, with the brush portion 76a of the brush member 76 being placed in contact with the slip rings 87, 88.

With the above, the slip ring fixing member 8 and the brush fixing member 7 are rendered rotatable relative to each other, while movements thereof in the rotational axis direction are restricted. Therefore, the brush fixing member 7 and the slip ring fixing member 8 are urged in directions away from each other under the urging force of the brush members 76. However, inadvertent withdrawal thereof is prevented by the anti-withdrawal projections 72a, 73a and the anti-withdrawal projections 81a, 82a. In this, as shown in FIG. 7, advantageously, the brush portions 76a of the brush members 76 are disposed on a same diameter of the slip rings 87, 88. With this arrangement, the urging force of the brush member 76 can be transmitted substantially uniformly in the peripheral direction, so that the relative rotation between the brush fixing member 7 and the slip ring fixing member 8 becomes smoother.

The power supply mechanism S provided as a unit as described above is assembled with the electromagnetic clutch 1. As shown in FIG. 8 the slip ring fixing member 8 of the power supply mechanism S is attached to the inside of the power mechanism side cover member 92. Inside the power supply unit side cover member 92, groove portions 92b are formed, and into these groove portions 92b, the plate-like conducting member 92c extending from the outer terminal portion 92d of the power supply mechanism side cover member 92 is provided. As the engaging portions formed in the slip ring fixing member 8 are engaged into the holes 92a formed in the power supply mechanism side cover member 92, the slip ring fixing member 8 is fixed. In this, as the phase fixing projection 85 formed on the slip ring fixing member 8 is inserted into the hole 92e defined in the power supply mechanism side cover member 92, the angular phase of the conducting member 92c and the angular phase of the terminal portions 87b, 88b of the slip rings 87, 88 are brought into agreement to each other. With this, the conducting member 92c and the slip rings 87, 88 are placed in contact with each other, thus being electrically connected to each other.

Further, as shown in FIG. 3, the rotor 4 is fixed to the rotor holding portion 71 on the side of the brush fixing member 7 of the power supply mechanism S. In this, the projections 52a projecting from the rotor 4 are inserted into the holes 71a, whereby the brush fixing member 7 and the rotor 4 are fixed to each other to be rotatable in unison. Further, as the terminal portions 53 projecting from the rotor 4 are inserted into the holes 75, the terminal portions 53 and the terminal portions 76b of the brush member 76 are electrically connected to each other.

Of the power supply mechanism S, the slip ring fixing member 8 is fixed to the power supply mechanism side cover member 92 and the brush fixing member 7 is rotatable together with the rotor 4. With this, during rotation of the rotor 4, the brush member 76 slides over the slip rings 87, 88 and power is supplied to the electromagnetic coil 5.

As described above, the slip ring fixing member 8 and the brush fixing member 7 are movable relative to each other within a predetermined range along the axial direction. Therefore, with such relative movement, an error or tolerance, if any, in the assembly of the entire apparatus is absorbed. On the other hand, as the brush member 76 is formed of an elastic material, when this is pressed against the slip rings 87, 88, the brush member urges the slip ring fixing member 8 and the brush fixing member 7 in directions away from each other. As a result, looseness in the axial direction can be prevented.

### Further Embodiments

(1) In the foregoing embodiment, there has been explained an example wherein the inner peripheral wall portion 42 is inclined to form the recess 41 with tapering. However, the inner peripheral wall portion 42 too, like the outer peripheral wall portion 43, may adopt an arrangement other than the above, such as the substantially perpendicular arrangement.

(2) In the foregoing embodiment, there has been explained a case wherein the elastic member 6 is fixed to the bobbin 50 which is rotatable in unison with the rotor 4. Instead, the elastic member 6 may be fixed to the rotor 4 per se. Further alternatively, the elastic member 6 may be fixed to the armature 3 or a member rotatable together with the armature 3 and may slidably contact the rotor 4 side.

(3) In the foregoing embodiment, as the elastic member 6, there was provided the dish spring 60 such as the one shown in FIG. 5. However, the invention is not limited thereto. In the case of the dish spring 60 shown in FIG. 5, when a force is applied to the center of the annular shape, this causes flexion and elastic deformation around the intermediate portion between the slidable contacting portion 61 and the tapered portion 62. In this, if the outer peripheral end of the dish spring 60 is formed continuous annularly, the deformation of the outer peripheral portion 66 along the radial direction will be restricted. For this reason, if the applied force is large, this may cause flip over of the intermediate portion to the opposite side, and this flip-over may generate a noise.

To cope with the above, for instance, as shown in FIG. 9, a plurality of slits 65 extending radially inward from the outer peripheral end may be provided in the outer peripheral portion 66. This arrangement allows radial displacement of the outer peripheral portion 66. Therefore, when the force along the center axis of the annular shape is applied to the dish spring 60, such flip-over of the intermediate portion as above will less likely occur, so that the generation of the noise from the flip-over may be restricted. This dish spring 60 includes an annular base portion 64 on the side to be fixed to the rotor 4 and a pawl portion 63 at the inner peripheral end of the base portion 64. Further, radially outward from the base portion 64, a tapered portion 62 and a slidable contacting portion 61 are formed and between the tapered portion 62 and the slidable contacting portion 61, slits 65 are formed. Therefore, this dish spring 60 can be fixed to the rotor 4 in a stable manner.

The slits 65 may be provided in a radial pattern along the radial direction as shown in FIG. 9 (a), or in a vortex pattern converged toward the radial inner side as shown in FIG. 9 (b). The radial pattern is advantageous as this facilitates the formation of the slits 65. In the case of the vortex pattern, even with us of a dish spring 60 having a same outer appearance and a plate thickness, the elastic coefficient can be adjusted steplessly by changing the length of the slit 65.

In the foregoing embodiment, as shown in FIG. 9, an annular low friction layer 61a may be formed along the entire periphery of the slidable contacting portion 61. In this case, in order not to block the radial displacement of the slidable contacting portion 61, advantageously, a portion of the low friction layer 61a is fixedly attached to the slidable contacting portion 61. Further, as shown in FIG. 10, on each slidable contacting portion 61 segmented in the peripheral direction by the slit 65, the low friction layer 61b may be formed. In this case, first, the low friction layer 61b will be formed on the slidable contacting portion 61, and then the slits 65 will be formed. Incidentally, as shown in FIG. 11, an annular low friction layer 61c having an angular hooked cross sectional shape may be attached to the slidable contacting portion.

(4) In the foregoing embodiment, the dish spring 60 was employed as the elastic member. This elastic member 6 can be a wave spring, etc., other than the dish spring 60. Further, the elastic member 6 need not be annular, but may be formed e.g. intermittently along the peripheral direction of the armature 3 and the rotor 4.

(5) In the foregoing embodiment, the rotor 4 was formed as a single component. Instead, as shown in FIG. 12 (a), this rotor 4 can be formed of a first member 4a and a second member 4b. The first member 4a has a circular annular shape and consists of an outer peripheral wall portion 43 forming the annular recess 41 for accommodating the bobbin 50 having the electromagnetic coil 5 wound around it, a bottom portion 45, and an inner peripheral wall portion 42. The second member 4b has a circulate plate-like shape and configured to engage with the first member 4a thereby to support this first member 4a rotatable in unison with the shaft 100.

The first member 4a is formed of a magnetic material so as to generate an attraction force by the magnetism to the armature 3, upon supply of electric power to the electromagnetic coil 5. For instance, this first member 4a can be obtained by effecting a drawing work on a circular annular plate-like magnetic material to form the outer peripheral wall portion 43, the bottom portion 45 and the inner peripheral wall portion 42. FIG. 12 shows the inner peripheral wall portion 42 and the outer peripheral wall portion 43 extending substantially perpendicular relative to the bottom portion 45. However, the invention is not limited to such arrangement.

On the other hand, the second member is to be fixed to the shaft 100. Therefore, taking its strength into consideration, this second member is formed of e.g. a non-magnetic material having higher strength than the magnetic material and at the center thereof, there is formed a hole 46 for receiving the shaft 100 inserted therein.

To the inner periphery of the inner peripheral wall portion 42 of the first member, the second member 4b is press-fitted, whereby, as shown in FIG. 12 (b), the first member 4a and the second member 4b are assembled together into a unit. In this, in order to prevent the second member 4b from coming into contact with the armature 3, the second member 4b will be press-fitted away from an end face 43a opposed to the armature and provided in the outer peripheral wall portion 43 of the first member. With this, of the rotor 4, only the end face 43a of the outer peripheral wall portion contacts the armature.

With the above described separate construction of the rotor 4 consisting of the first member 4a and the second member 4b, even when the annular recess 41 is formed by a drawing work, the face of the recess 41 on the side of the bottom portion 44 will be the bent side, and the face thereof opposed to the armature 3 will not be the bent side. For this reason, the end faces 42a, 43a as the faces opposed to the armature 3 and the inner lateral face of the recess 41 will be formed substantially perpendicular, so that the air gap between the rotor 4 and the armature 3 can be reduced. Consequently, there is no need to employ a very large electromagnetic coil, so the electromagnetic clutch 1 can be formed compact.

(6) In the foregoing embodiment, of the rotor 4, only its end face 43a of the outer peripheral wall portion 43 comes into contact with the armature 3. However, the invention is not limited to the above embodiment. For instance, alternatively, it is possible to arrange such that both the end face 43a of the outer peripheral wall 43 and the end face 42a of the inner peripheral wall 42 come into contact with the armature 3.

(7) Further, the power supply mechanism S is not limited to the above. Instead, the mechanism can have a different arrangement that the brush members 76 are provided directly on the rotor 4 and the slip rings 87, 88 are provided directly on the power supply mechanism side cover member 92. Moreover, the mounting arrangements of the brush members 76 and the slip rings 87, 88 are not limited to those described above. For instance, the mounting can comprise fixing with screws, etc. Further, the power supply mechanism can be other than the above-described power supply mechanism S using the brush members 76 and the slip rings 87, 88, such as a power supply mechanism using harness.

(8) In the foregoing embodiment, there was explained an example wherein the electromagnetic coil 5 is rotated in unison with the rotor 4. Instead, the electromagnetic coil 5 can be fixed in the space opposite to the opposing face of the rotor 4 opposed to the armature 3, so that the rotor 4 alone is rotated.

(9) In the foregoing embodiment, the electromagnetic clutch 1 according to the present invention was employed in the actuator A for a powered slide door of an automobile. Instead, this electromagnetic clutch may be employed in any other way than the actuator A for a powered slide door of an automobile.

(10) In the foregoing embodiment, there was explained a case wherein between the rotor 4 and the armature 3, there is interposed an elastic member configured to urge the rotor 4 and the armature 3 in directions away from each other. However, this elastic member need not always be provided. Instead, it is possible to arrange such that the rotor 4 and the armature 3 comes into slidable contact to rotate relative to each other at the time of no power supply to the electromagnetic coil 5.

For instance, the electromagnetic clutch may comprise a worm wheel driven by a drive motor, an armature rotatable in operative association with the worm wheel, a rotor rotatable about a same rotational axis as the armature, and an electromagnetic coil accommodated in an annular recess formed in a face of the rotor opposed to the armature and configured to move and pull the rotor and the armature with magnetic force into contact with each other along a rotational axis, wherein the rotor is formed by effecting a drawing work on a material and configured such that the inner peripheral wall portion of the recess has an inner diameter that progressively decreases from a bottom portion of the recess toward the opening.

When the rotor is formed by a drawing work effected on a material as in the above construction, there is no need to effect e.g. a cutting work. So, the manufacturing cost of the rotor can be reduced. Further, if the inner peripheral wall portion is configured as described above, as compared with a case of forming the inner peripheral wall portion perpendicular relative to the bottom portion, it is possible to prevent unneeded extension of the inner peripheral wall portion in the course of drawing work, thus ensuring sufficient thickness for the inner peripheral wall portion. Moreover, the bending amount of the material at the border between the inner peripheral face of the recess and the opposition face to the armature may be small, thus preventing the border portion from being roundish. As a result, the air gap at the border portion relative to the armature can be reduced. Therefore, it becomes easier to secure sufficient force of attraction for the rotor relative to the armature and there is no need to employ a very large electromagnetic coil. Consequently, the electromagnetic clutch may be formed even more compact at even lower costs.

Further, according to another advantageous arrangement, when the rotor and the armature are pulled into contact with each other, only the end face of the outer peripheral wall portion of the recess opposed to the armature comes into contact with the armature. With this arrangement, the radius of contact between the rotor and the armature can be large, so that the rotational torque can be increased.

According to a further advantageous arrangement, a radial width of the end face of the outer peripheral wall portion of the recess opposed to the armature and a radial width of the end face of the inner peripheral wall portion of the recess opposed to the armature are set such that areas of said end faces may be equal to each other. With the above-descried setting of the radial widths of the end faces, passing magnetic flux densities of the end faces are rendered each to each other, thus the magnetic flux may flow smoothly.

(11) As another embodiment having no elastic member interposed between the rotor and the armature for urging these rotor and armature in directions away from each other, a further arrangement will be explained. In this, the electromagnetic comprises a worm wheel driven by a drive motor, an armature rotatable in operative association with the worm wheel, a rotor rotatable about a same rotational axis as the armature, and an electromagnetic coil accommodated in an annular recess formed in a face of the rotor opposed to the armature and configured to move and pull the rotor and the armature with magnetic force into contact with each other along a rotational axis, wherein the rotor includes a first member comprising an outer peripheral wall portion, a bottom portion and an inner peripheral wall portion that together form the recess, and a second member engageable with the first member and supporting the first member rotatably about the rotational axis.

If the rotor is formed of two separate members, i.e. the first member and the second member, even when the annular recess is formed by a drawing work, the bottom portion of the recess becomes the bending side. Therefore, the border between the face of the rotor opposed to the armature and the inner peripheral wall of the recess may be formed substantially perpendicular, thus reducing the air gap relative to the armature. Hence, there is no need to employ a very large electromagnetic coil. Consequently, the electromagnetic clutch may be formed even more compact at even lower costs.

According to another preferred arrangement, the second member is fitted under pressure to the inner side of the inner peripheral wall portion of the first member. With this arrangement, with the simple arrangement of pressure-fitting the first member to the second member, the rotor can be formed. As a result, even more cost reduction is made possible.

According to another preferred arrangement, the first member is formed of a magnetic material and the second member is formed of a non-magnetic material. If the first member and the second member are formed of different materials as in the above construction, for the second member in particular, its forming material may be selected appropriately, with taking into consideration such factors as readiness of working, strength required in its fixing to the rotational shaft. Therefore, the manufacture of the rotor becomes easier and even further cost reduction is made possible.

### INDUSTRIAL APPLICABILITY

The present invention may be used in an electromagnetic clutch comprising a worm wheel driven by a drive motor, an armature rotatable in operative association with the worm wheel, a rotor rotatable about a same rotational axis as the armature, and an electromagnetic coil accommodated in an annular recess formed in a face of the rotor opposed to the armature and configured to move and pull the rotor and the armature with magnetic force into contact with each other along a rotational axis.

1. An electromagnetic clutch comprising:
a worm wheel driven by a drive motor;
an armature rotated in operative association with the worm wheel;
a rotor rotatable about a same axis as the armature;
an electromagnetic coil configured to cause the rotor to generate a magnetic force for causing the rotor and the armature to be moved and pulled into contact with each other along the rotational axis by the magnetic force; and
an elastic member interposed between the rotor and the armature, one side of the elastic member being fixed to one of the rotor and the armature, the other side of the elastic member being in slidable contact with the other of the rotor and the armature, the elastic member urging the rotor and the armature in directions away from each other.

2. The electromagnetic clutch according to claim 1, wherein in a face of the rotor opposed to the armature, there is formed a recess for accommodating the electromagnetic coil, and the elastic member is provided in a space between the recess and the armature.

3. The electromagnetic clutch according to claim 2, wherein the recess and the elastic member are formed annular.

4. The electromagnetic clutch according to claim 3, wherein the elastic member includes a pawl portion along the peripheral direction, the pawl portion being fixed to one of the rotor and the armature.

5. The electromagnetic clutch according to claim 3, wherein the elastic member includes an annular slidable contacting portion configured to slidably contact either one of the rotor and the armature and an annular tapered portion extending with tapering such that the diameter thereof progressively decreases toward the other of the rotor and the armature.

6. The electromagnetic clutch according to claim 3, wherein the elastic member comprises a dish spring.

7. The electromagnetic clutch according to claim 3, wherein the elastic member includes a plurality of slits extending either radially inward from its outer peripheral end or radially outward from its inner peripheral end.

8. The electromagnetic clutch according to claim 3, wherein the elastic member is disposed along the vicinity of the outer peripheral portion of at least one of the rotor and the armature.

9. The electromagnetic clutch according to claim 3, wherein the elastic member is fixed in the vicinity of the inner peripheral wall portion of the recess and the elastic member extends radially outward such that an outer peripheral portion thereof is located adjacent the outer peripheral wall portion of the recess.

10. The electromagnetic clutch according to claim 1, wherein the elastic member has a low friction layer that slidably contacts the rotor or the armature.

11. The electromagnetic clutch according to claim 2, wherein the rotor is formed by a drawing work on a material and the inner peripheral wall portion of the recess is configured such that its inner diameter progressively decreases from a bottom portion of the recess toward its opening side.

12. The electromagnetic clutch according to claim 2, wherein when the rotor and the armature are pulled into contact with each other, only the end face of the outer peripheral wall portion of the recess opposed to the armature comes into contact with the armature.

13. The electromagnetic clutch according to claim 2, wherein a radial width of the end face of the outer peripheral wall portion of the recess opposed to the armature and a radial width of the end face of the inner peripheral wall portion of the recess opposed to the armature are set such that areas of said end faces may be equal to each other.

14. The electromagnetic clutch according to claim 2, wherein the rotor includes a first member comprising an outer peripheral wall portion, a bottom portion and an inner peripheral wall portion that together form the recess, and a second member engageable with the first member and supporting the first member rotatably about the rotational axis.

15. The electromagnetic clutch according to claim 14, wherein the second member is fitted under pressure to the inner side of the inner peripheral wall portion of the first member.

16. The electromagnetic clutch according to claim 14, wherein the first member is formed of a magnetic material and the second member is formed of a non-magnetic material.
